(19) United States
(12) Patent Application Publication
(10) Pub. No.: US 2014/0095261 A1
(43) Pub. Date: Apr. 3, 2014

(54) METHODS, APPARATUS AND SYSTEMS FOR DETERMINING STAND POPULATION, STAND CONSISTENCY AND STAND QUALITY IN AN AGRICULTURAL CROP AND ALERTING USERS

(71) Applicant: FI2 Solutions, LLC, Mankato, MN (US)

(72) Inventor: Jerome D. Johnson, Waterville, MN (US)

(73) Assignee: FI2 Solutions, LLC, Mankato, MN (US)

(21) Appl. No.: 14/095,331

(22) Filed: Dec. 3, 2013

Related U.S. Application Data
(63) Continuation of application No. 13/628,803, filed on Sep. 27, 2012.

(51) Int. Cl. G06Q 30/02; G06Q 50/02

(52) U.S. Cl. CPC G06Q 30/0205; G06Q 50/02
USPC 705/7.34

(57) ABSTRACT

A computer-based system for combining data related to stand population, consistency and quality in agricultural crops and dynamically analyzing the data whereby stand determinations based on that analysis during a crop growing season can be made. The system is programmed to alert a user (farmer) or other designated parties when the stand fails to meet user-defined parameters.

### CROSS-REFERENCE TO RELATED APPLICATION(S)

This application is a continuation of U.S. patent application Ser. No. 13/628,803 filed Sep. 27, 2012, the entire contents of which are hereby incorporated by reference.

### BACKGROUND

I. Field of the Invention

The present invention relates to the methods, graphical user interfaces (GUI), computer-readable media, and systems for combining multiple types of data and data sources including in-season data related to agricultural crops and crop economics, dynamically analyzing the data to determine stand population, stand quality, and stand consistency status of the recently emerged crop (hereafter referred to as “stand”) and based on that status automatically provide alerts to the user, or other designated parties, concerning that status. The present invention determines if there are stand deficiencies by exact GIS location and alerts the user in a timely manner during the crop season such that corrective action can be taken, practices can be improved during the following growing seasons and/or crop marketing strategies may be modified. The determinations can be executed repeatedly and consistently in a cost-effective, scalable manner and without requiring special agronomic or technical skills. The present invention relates to computing devices, and more particularly to computing devices for use in determining a status of growing crops.

II. Background

It is well known that the quality of the stand of a crop has a direct impact on the quality of the harvested crop as well as on the yield and income for the person managing the crop. The present document defines “stand population” as the number of plants that have emerged, started growth, are healthy, and are capable of producing a high quality, high yielding crop. As used herein, the term “stand consistency” is defined as the variability of the planting across a field or portion of a field including multiple plants grouped together and other unintended irregularities, such as skips or areas where there are no plants or a minimal number of plants. “Stand quality” is defined as the general health of the plant. Within this document the term “stand” will be used to describe plant population per unit area, stand consistency, and stand quality.

Identifying a targeted stand and then achieving that stand has long been recognized for its importance by farmers who have made and continue to make large investments in planting equipment in an attempt to improve stand accuracy. This planting equipment includes sophisticated machinery and electronics to control and monitor every aspect of planting, such as seed depth, row unit down pressure, seed singulation, seed spacing, measuring doubles and skips, and the like. The planting equipment often measures its motion while the seed is being planted to be sure the planter has a smooth ride. A smooth ride should translate to better control of the planter and greater planting precision which will ultimately result in placing the seed in the right location and resulting in the right spacing (population) between plants, and therefore an improved stand. Another example of the effort taken by farmers to establish a specific stand is illustrated in the planting equipment electronics where a monitor provides the farmer with a real-time measure of the effectiveness of the planter in achieving the desired stand. The aforementioned electronics provide a real-time measure of seed placement as the planting equipment moves across the field and translates any planting irregularities into anticipated yield loss. For example, one type of monitor has a display which can show a reading such as −$20 or −$30/acre; this is an anticipated yield/economic loss per acre based on the current planter performance in placing the seed in the ground precisely as planned.

Seed companies have developed and continue to improve seed genetics in many areas including seed germination and early-seed vigor with the intention of improving stand and getting a crop off to a good start. Universities, the USDA, and Extension offices have performed research relating to the impact of the planting date, soil and air temperature, tillage practices, residue, and other factors in an attempt to develop practices that will improve stand development. Clearly, farmers, suppliers, OEMs, research organizations, and the like understand the importance of a high quality and accurate stand and have expended a large amount of effort to improve the stand, and ultimately the yield, crop quality, and financial outcome.

At the present time, great care and precision is used to determine an ideal target stand for a field and/or portion of a field and then to achieve the target stand as the seed is placed in the ground. For some crops, the equipment, systems, and practices used to achieve this precision in planning and placing (planting) the seed is collectively identified as “precision agriculture.” However, final stand quality is ultimately determined by both the placement, practices, and seed genetics, as well as a number of other conditions and events the seed and resulting plants are exposed to after planting. These conditions impact stand performance to different degrees and are variable from year to year, region to region, farmer to farmer, crop to crop, field to field, and between and within crop rows. Examples of the factors that affect the seed and impact the ultimate stand include:

Soil temperature

Soil moisture

Tillage practices

Ground residue coverage

Accuracy of the planter and planter electronics

Planter operator skill

Soil compaction

Seed bed condition (clods, etc.)

Soil surface crusting

Germination rate of the seed (quality of the seed)
Insects feeding on seeds

After the crop emerges, the plants are exposed to another set of conditions that determine the final crop stand that will be harvested. These conditions are especially impactful when the plant is young and fragile early in its growth cycle. Exemplary factors are:

Excess rain including ponding and flooding, especially in low lying areas

Erosion

Hail

Lack of rain

Frost

Air temperature

Wind

Diseases

Insects

Weeds

Pests

Stand expectations based on careful planning and execution of precision planting and the use of expensive equipment and high quality seed may not be realized due to external events and conditions. These external events and conditions ultimately impact yield, crop quality, and income. It should be noted that the stand at harvest is a direct result of the impact of all of these factors occurring over the crop growth cycle.

When a stand is less than what is intended and is discovered early in the growing season, then replanting of the crop or of another crop is a possible remedy; however every delay in replanting, even by one day, limits these options. This is especially true in regions where the growing seasons are shorter. Also, when stands vary across the field, interplanting alongside the original crop row may be another option. Understanding where existing plants are (and are not) can lead to a customized prescription that instructs the planter to place interplanted seed exactly where they are needed. Even if no corrective actions can be taken in a given crop year (other than a possible insurance claim, which is a viable option in some cases), understanding actual stand quality across his or her fields may help a farmer improve his or her ability to predict yield and therefore improve marketing practices. Finally, understanding the actual stand provides information such that corrective action can be taken in subsequent years to improve future crops' stand. Possible ways to improve stand in subsequent years are through improved practices, seed selection, planning, equipment use, planting execution, and a wide variety of other corrective actions.

As previously described, there have been significant product, technical, practical, and genetic improvements designed to positively impact stand. However, the methods to actually determine stand after plant emergence and to monitor the stand as the crop is subject to external factors and events have not advanced. They are manual in nature and measure stand only in the portion of the field that is monitored. The following techniques were published by Iowa State University in 2012 and are recommendations for farmers who want to determine stand. They reflect the current state of the art in determining stand.

1/1000th Acre Method
Count the number of plants in a length of row equal to 1/1000th of an acre based on row width. Multiply the number of plants by 1,000 to get plants per acre. Repeat the process in several locations in the field.

Wheel Method
Count 150 plants and measure the distance from start to finish with a measuring wheel. Divide the number of feet traveled into the appropriate factor in Table 2 to determine plant population. For example, if you walked 94 feet while counting 150 plants in 30-inch rows, the population is 2,613,600÷94=27,804 plants per acre.

Hoop Method
Measure the diameter of the hoop, toss it in the field, and count the number of plants inside the hoop. Do this in at least 5 locations in the field. Multiply the average number of plants by the appropriate factor listed in Table 3 to get the number of plants per acre. Notice that having a diameter of 28¼″ allows you to simply multiply by 10,000 to obtain the number of plants per acre. This size of hoop can be made by cutting anhydrous tubing to 88¾ inches and joining it to form a circle.”

These techniques measure stand in terms of population and only measure it within limited portions of a field, and therefore do not reflect the stand across the entire field. Furthermore, this simple analysis does not record the stand spatially across the field. The random sampling of stand quality may be acceptable within the measured area, however this measurement may not reflect the stand across the entire field. Seeds that are planted are subject to factors that undermine stand quality across a field. Therefore, even seeds that are initially planted and spaced with great care, when subjected to varying field conditions, often result in stands that are inconsistent across the field. A good example may be a field that is subject to a hail storm. The hail may randomly impact particular plants resulting in portions of the field where the stand is not impacted and other areas where there are gaps in plant development. This results in areas within a field where the stand is as intended and other areas where there are gaps or no plants at all. As a result, stand population may be minimally impacted, and yet stand consistency is varied, and the total yield will be impacted. There are currently no known ways to measure stand consistency other than through visual inspection by someone with skill in the art and with the time to inspect the crop carefully, often, and broadly.

The final measure of a stand is the quality of the stand. By quality, we are focusing on the health of the plant. A plant that is not healthy will not add to yield, in fact it may be considered as a type of weed depriving the healthy plants of the water, nutrients, sun and other factors necessary to produce a high quality, high yielding crop. In the present document, stand population, stand quality and stand consistency are used interchangably to characterize stand.

The primary problem addressed by the present invention is the ability to determine the actual stand population, stand consistency, and/or stand quality across an entire field without technical or agronomic skills on an on-going basis with frequency and accuracy. The present invention includes the ability to automatically process and analyze multiple types of data in combination to accurately determine stand. Data types include field and crop data and real-time or near real-time data produced by a UAV (unmanned aerial vehicle), flying camera, flying robot, satellite, airplane, and/or ground-located sensor.

Another problem addressed by the present invention is the ability to re-determine the stand on an on-going basis as the crop starts its growth and is exposed to an unending variety of conditions that undermine the stand.

The present invention also addresses the problem of determining stand for all parts of an entire field rather than only samples across a field.

Furthermore, the invention has the ability to determine plant variability row by row so that interplanting or replanting prescriptions can be made.

Finally, the present invention has the ability to notify the farmer (grower, farm manager, consultant, supplier, contractor, or other person with the responsibility to achieve yield, crop quality, and revenue goals) to make him or her aware of the stand status in a timely manner. These alerts include relevant information including the field location and the stand issue location within the field to aid in executing a possible remedy.

In addition, the present invention determines the stand status and notifies the user in a scalable and cost effective manner. It should also be noted that the economics of taking corrective action are an important factor in determining “what to do”, if anything. As the growing season progresses, there is a diminishing economic return on corrective action in the case of poor stand. The time of the year and the length of the growing season can limit the prudence of taking corrective action from an economic standpoint.

### SUMMARY

Methods, apparatus and systems for determining stand population, stand quality, and stand consistency in an agricultural crop and alerting users such that corrective action can be taken are herein described. The stand determination and alert system is comprised of a user interface, data feeds, data sources, a communication network, a stand analyzer and alert generator, and a database. Information regarding stand determination may be received from a variety of sources, such as a user, a database, a data feed, a social network, an Internet-based data source, an unmanned aerial vehicle (UAV), an in-field sensor, and/or equipment, via a communication network, such as the Internet, a cloud computing network, a local area network (LAN), a wide area network (WAN), or a wireless LAN (WLAN).

The user interface may be configured to receive an alert, analysis, and status from a Stand Analyzer and Alert Generator via the communication network, provide the stand status to the user, receive information regarding the local information, field data, planned events, and local knowledge from the user, and provide the received information to the Stand Analyzer and Alert Generator. Optionally, the system may further include a database communicatively coupled to the Stand Analyzer and Alert Generator that is configured to store the received stand information as well as data related to stand information.

The received information may be processed and analyzed to determine crop stand in a field and/or in a portion of a field. The stand population, consistency, and quality is determined based on an analysis of data related to the stand, for example, processed image data of the crop including patterns, color, images, texture, shape and shadows, and/or electronically enhanced or modified images. This data, in combination with other data, such as field data (soil types and textures), topography, weather data, planter data, seed performance data, and data from other farmers from what may be described as a social network, is used to determine if stand deficiencies exist. This analysis is intended to determine stand population, stand consistency, and/or stand quality deficiencies that may impact crop yield and quality so that the user can take corrective action and/or modify plans. The stand status that is detected may encompass an entire agricultural field or a portion of the field. If the deficiencies are determined to be within a defined parameter of acceptability, no alert or notification will be issued to the user or other designated party. However, if the stand status falls outside the defined parameter of acceptability, the Stand Analyzer and Alert Generator will issue the appropriate notification. It is important to note that financial considerations such as cost of corrective action as well as impact of doing nothing may be a factor when the generator triggers an alert.

For the present invention, the user is generally assumed to be a farmer or other person who manages an agricultural crop. The aforementioned designated parties might include agricultural product and service suppliers and consultants, agricultural product buyers, agricultural landlords and bankers, or other persons who have a vested interest and/or responsibility in the growth and outcomes of an agricultural crop.

All of the data incorporated into the stand determination alert system is derived from the user, the user's equipment, a UAV (or other flying device, collectively identified as a UAV in the present document), active or passive sensors, satellites, other farmers, and/or commercial and/or public free and fee-based data sources. The Graphical User Interface (GUI) may be configured to receive data from the user concerning the agricultural crop. This data may relate to the agricultural fields (location, size, shape, ID, or name), planned events (planting and chemical application dates, types, and locations), and local knowledge (including, but not limited to, the user's preferences and experiences, and his or her personal visual inspections of the crop). All other data may be received from other sources via a communication network. This data incorporated into the Stand Analyzer and Alert Generator may be from, for example, a UAV in the form of in-season data images or other sensed data or from Internet-based data sources, relating to field data (soil types, weather patterns, climate, slope, etc.), unplanned events (current weather data, etc.), and scientific and agronomic data (including, but not limited to, known best practices, stand research, seed genetics and performance characteristics, plant research, and data). On some occasions, an attribute of the received information may be determined and the received information may be incorporated into a corresponding attribute of the database. For example, when an attribute of the received information relates to the field's condition, it may be incorporated into a corresponding field condition attribute.

A portion of the data that the user enters relates to his or her preferences in how the Stand Analyzer and Alert Generator receives and analyzes the data, the parameters around how and when the system notifies the user or other designated parties of stand deficiencies, any exclusions that the user desires to be exempt from the analyzed data, and the manner and method by which the user, and/or other designated parties, are alerted to potential stand deficiencies.

The Stand Analyzer and Alert Generator sends alerts to the user, and/or other designated parties, through the communication network and the GUI. In one embodiment, this notification may take the form of a text message or a phone message. In another embodiment, this notification may include maps to specify the location, size, and shape of the area where the stand deficiency has been determined and it falls outside the user's established acceptability parameters. It may also include a visual analysis in the form of a chart or graph displaying determinations, locations, trends, and comparative or benchmark data. The user may alter data display preferences to get a more nuanced view of the stand determination data. In one embodiment, an example of a data display preference is the ability of the user to exclude geographic areas within his or her fields that he or she does not want included within the stand analysis area. This exclusion allows the user to remove from consideration data and/or areas of a field that are physically incongruent with the rest of the field (e.g., ditches, rock piles, former building sites, etc.) and therefore skew or distort the overall dataset and the resulting determinations. If, in this example, the user desires to exclude a portion of his or her field due to information known only at the local level, such as the presence of a former building site or a manure or fertilizer spill in the past, that data will not be incorporated into the analysis performed by the stand determination analyzer and alert system, and therefore not incorrectly impact the system's determination of whether or not a stand determination alert is deemed necessary to be issued to the user.

Iterations of data gathering/receiving events may occur over a period of time, providing the user with comparative data of the same crop in the same field over time. Likewise, through the use of social networks, peer users may compare their stands with others, including those other users who have crops in relative proximity and therefore are subject to similar environmental conditions (soil types, climate, weather, seed varieties, pests, etc.). In another embodiment, the user may be able to personally view the underlying data. Alerts may also be issued to other interested parties, as designated by the user. These alerts are intended to keep the suppliers, buyers, landlords, and others abreast of the in-season crop growth and stand progress.

### BRIEF DESCRIPTION OF THE DRAWINGS

The foregoing features, objects and advantages of the invention will become apparent to those skilled in the art from the following detailed description of a preferred embodiment, especially when considered in conjunction with the accompanying drawings in which like numerals and the several views refer to corresponding parts.

FIG. 1 is a system block diagram of a standsystem in accordance with the present invention;

FIG. 2 is a block diagram representation of sets of data bases employed in the system of FIG. 1;

FIG. 3 is a graphical representation of types of data contained in the data bases;

FIG. 4A is a flow chart for a process used to generate a stand determination alert;

FIG. 4B is a more detailed flow chart showing a process for carrying out step 405 of FIG. 4A;

FIG. 4C is a more detailed flow chart showing a process for carrying out step 415 of FIG. 4A;

FIG. 4D is a table illustrating a method for arriving at scores for the grids derived in step 410 of FIG. 4A;

FIG. 4E is a further flow chart of the steps for notifying a user of changes in stand determinations;

FIG. 5 is a flow chart showing the steps in collecting in-season imagery of plant conditions;

FIG. 6 illustrates aspects of Graphical User Interface screens derived in accordance with the method of the present invention over a period of time reflecting changes in crop conditions;

FIG. 7 represents the contents of an alert message;

FIG. 8 is an illustrative screen shot of a User Interface relating to a specific field;

FIG. 9 is an illustrative screen shot, like that of FIG. 8, but with the grids into which the field is divided being shown;

FIG. 10 is an alert message received reflecting a stand deficiency;

FIG. 11 is a screen shot following the triggering of an alert of a problem in a field;

FIG. 12 is a screen shot showing the type of information provided by the stand analyzer and alert generator;

FIG. 13 is a screen shot of a typical alert message relating to the occurrence of severe weather;

FIG. 14 is a screen shot of an alert message based upon an aerial inspection following a hail storm; and

FIG. 15 shows a User Interface useful in reviewing stand determination based on aerial imagery following storm damage to a crop.

### DETAILED DESCRIPTION

The present invention describes methods and systems to combine, analyze, and process various types of data from various sources to determine in-season stand determination and generate notifications that may be provided to and used by people engaged in agricultural operations. Stand determinations and notifications, or alerts, generated in accordance with the present invention may include reasons detailing the cause of said alerts. In some embodiments, a user may be able to manipulate various aspects of the defined parameters, described as triggers in the present document, of stand acceptability in order to ensure that he or she will receive alerts when those alerts are the most effective and useful for that particular user and not become a nuisance, such as the proverbial boy crying wolf. The stand analyzer and alert system includes the process by which stand data is collected and analyzed, and the method by which the resulting stand determination is reported to the user based on his or her pre-established parameters of acceptability.

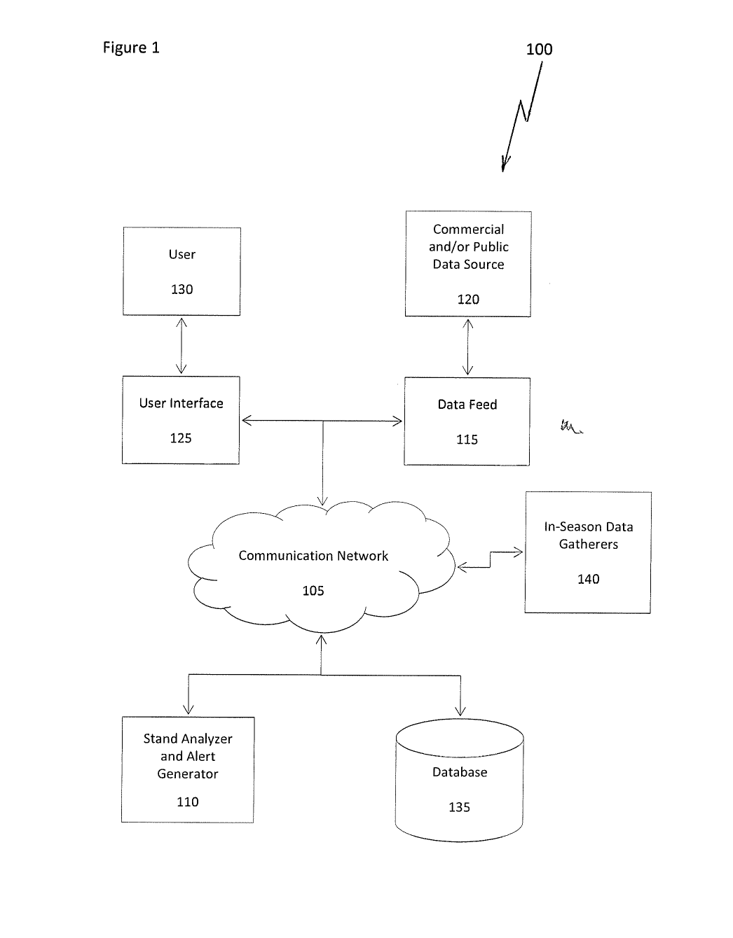

Turning now to FIG. 1, a block diagram depicting an exemplary system 100 for executing one or more of the processes described herein is illustrated. System 100 includes a Communication Network 105, which communicatively couples a Stand Analyzer and Alert Generator 110, a database 135, a user interface 125 (associated with a user 130), a Data Feed 115 (associated with commercial and/or public data source 120), and an In-season Data Gatherer 140. Note, although only one Communication Network 105 is shown in the illustration, there may, in fact, be multiple such networks and internetworks involved and such networks and internetworks are being grouped together for purposes of simplifying the present discussion. Further, in some instances some of the components illustrated in FIG. 1 may be combined or may be absent from instantiations of the present invention. For example, once the stand determination alert has been generated, user 130 may view the alert on personal computers, laptops, tablet computers, smart phones, or other portable computer-based devices, in which case the stand determination alert information may be self-contained and access to the communication network and other elements of system 100 may not be required until the stand determination alert or information concerning the stand determination needs to be modified or updated. Although only one user interface is shown, multiple such interfaces may exist. Thus, system 100 in FIG. 1 should best be regarded merely as an example of a system in which the present invention finds application.

As indicated, Communication Network 105 communicatively couples the other elements of system 100 to one another. Exemplary Communication Networks 105 include Cloud computing networks, the Internet, local area networks (LAN), wireless local area networks (WLAN), and wide area networks (WAN). Usually, though not necessarily, User 130 may connect to system 100 periodically to change his or her preferences (e.g., include or exclude certain geographic areas for the system's analysis, change the sensitivity parameters that the user has pre-established, or make other modifications). In some cases, Users 130 may communicate status to other Users 130 such as employees, consultants, buyers, suppliers, bankers, landlords, and other farmers. In some embodiments, multiple Users 130 may be enabled to communicate with one another via a Communication Network 105 in a manner similar to, for example, a social network. This information may be useful to establish stand determination findings that extend beyond a singular operation. In some embodiments, Stand Analyzer and Alert Generator 110 may reside on a computer-based platform, such as a server or set of servers. Such a server may be a physical server or a virtual machine executing on another hardware platform, however, the precise nature of such a configuration is not critical to the present invention.

Such a server, indeed all of the computer-based systems which are discussed herein, will be generally characterized by one or more processors and associated processing elements and storage devices communicatively interconnected to one another by one or more busses or other communication mechanism for communicating information. Storage within such devices will usually include a main memory, such as a random access memory (RAM) or other dynamic storage devices, for storing information and instructions to be executed by the processor(s) and for storing temporary variables or other intermediate information during the use of the stand determination alert system described herein. Such a computer system will also include some form of read only memory (ROM) or other static storage device for storing static information and instructions for the processor(s). A storage device, such as a hard disk or solid state memory may also be included for storing information and instructions, such as the instructions to compute stand determination from externally gathered image data, and issue alerts if so required based on the pre-defined acceptability parameters. RAMs, ROMs, hard disks, solid state memories, and the like, are all examples of tangible computer readable media, which may be used to store the instructions which comprise the methods for determining the necessity of generating and presenting stand determination alerts in accordance with embodiments of the present invention. Execution of such instructions causes the various computer-based elements of system 100 to perform the processes described herein, although in some instances, hard-wired circuitry may be used in place of or in combination with such computer-readable instructions to implement the invention.

To facilitate user interaction, collection of information, and provision of results, the computer systems described herein will typically include some form of a display device, though such a display may not be included with the server, which typically communicates results to a client/manager station (via an associated client/manager interface) rather than presenting the same locally. Client/manager stations will also typically include one or more input devices such as keyboards and/or mice (or similar input devices) for communicating information and command selections to the local station(s) and/or server(s).

To facilitate the network communications alluded to above, the various computer devices associated with system 100 typically include a communication interface that provides a two-way data communication path. For example, such communication interfaces may be Ethernet or other modems to provide a wired data communication connection or a wireless communication interface for communication via one or more wireless communication protocols. In any such implementation, the communication interface will send and receive electrical, electromagnetic, or optical signals that carry digital data streams representing various types of information. This facilitates the exchange of data, including stand determination and alert information, through Network(s) 105 as described herein.

Stand Analyzer and Alert Generator 110 may be configured to generate a stand alert by receiving input from User 130, Data Feed 115, Commercial and/or Public Data Sources 120, In-season Data Gatherer 140, and/or accessing data stored in Database 135. Stand Analyzer and Alert Generator 110 may use historical crop information in order to, for example, determine stand based on past field or seed stand performance and/or practices such as planting or tillage that have impacted stand.

Data Feed 115 may provide remotely gathered data relating to, for example, vegetation characteristics, weather, climate, and geological data and events (e.g., thunderstorms, floods, etc.). Data Feed 115 may be provided by, for example, various public (e.g., the U.S. Department of Agriculture or the National Oceanic and Atmospheric Administration) or private sources and may be so provided on a fee or fee-free basis. Stand Analyzer and Alert Generator 110 may automatically include consideration of historically known climate conditions (e.g., historic temperature or rainfall, etc.) for a geographic location when generating a stand alert. On some occasions, a data feed may be associated with a system used by or provided by an agricultural product supplier. On some occasions, Data Feed 115 may be provided by a social networking service (e.g., Twitter, Facebook). In this way, one or more users may communicate information between one another that may be relevant to stand determination, status updates of current stand statuses for peer farmers, or stand treatment prescriptions and strategies of peer farmers. Stand alerts may be generated in a partially or wholly automated manner by Stand Analyzer and Alert Generator 110 analyzing, for example, peer group data, historical, real-time, or known data relating to stand determinations.

Exemplary Commercial and/or Public Data Sources 120 include the Internet (public and private data services), combines, planters, and other equipment used to execute various agricultural practices. Other Commercial and/or Public Data Sources 120 may be academic and/or research organizations, suppliers of crop inputs, buyers of crops, and peer farmers.

In-season Data Gatherers 140 may include UAVs, aircrafts, satellites, and/or in-field sensors to measure field and crop conditions for one or more crops and fields or portions of fields included within the stand analyzer and alert system monitored area. The measurements are of the target field's stand condition, including but not limited to data related to crop color (traditional, red, infrared, green, and blue), patterns, tone, texture, shape, shadow, temperature, size of the area, the intuited stand statuses, and/or information concerning the larger area in proximity to the targeted field or portion of that field. For the sake of this document, UAVs are the preferred data source for in-season crop condition data based on their ability to gather data in a timely, quick, scalable, and economical fashion.

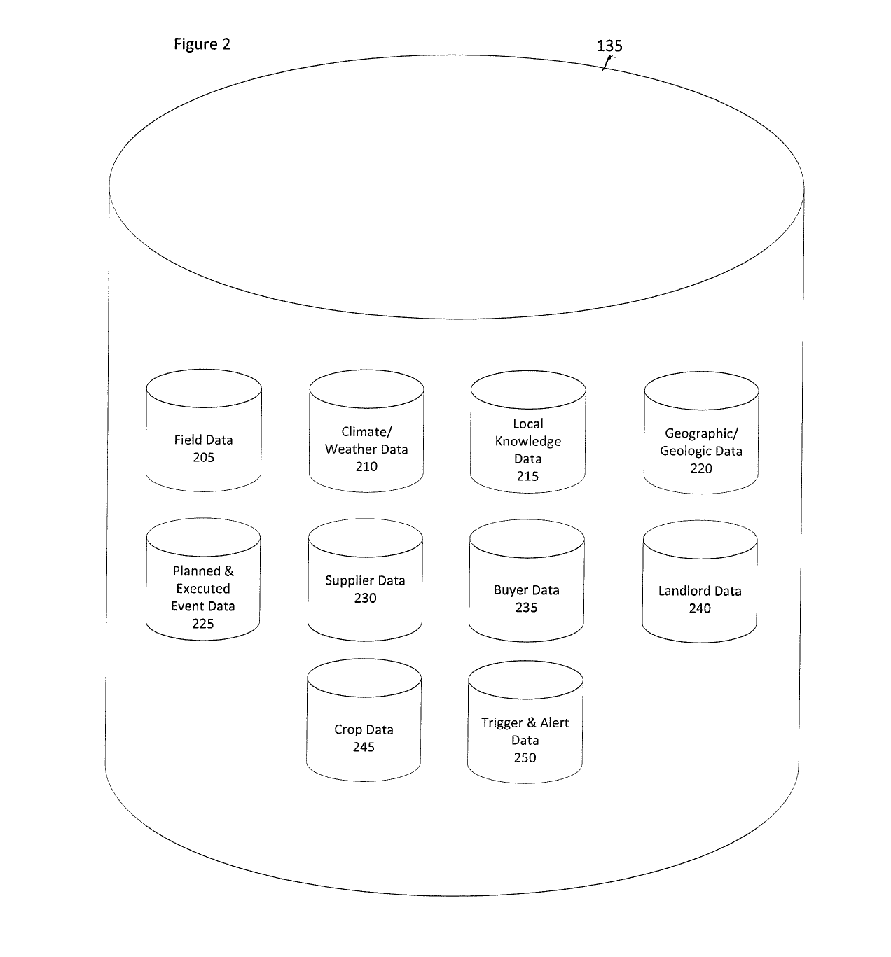

Database 135 may be one or a series of databases linked together and in communication with Stand Analyzer and Alert Generator 110. Database 135 may store data related to any facet of stand determination including, for example, current and historical data, including imagery produced by a UAV, satellite, or other aerial device, other ground-based sensor device, or other hand-held device. Database 135 may also include field location, soil characteristics, topography, historical weather, crop data, such as crop type, seed variety and other seed performance characteristics, other crop characteristics and practices (such as when and how the field is tilled and planted), historical nutrient measurements, historical yield maps, notes, local knowledge, and planned events. Further details regarding the information stored in Database 135 are discussed below with regard to FIG. 2.

Generating a stand determination alert can involve the User 130 manually selecting or entering, for example, various observations and preferences for the area (e.g., areas to exclude, visually determined conditions, and/or notification trigger parameters) using the User Interface 125. A user may enter local knowledge into Stand Analyzer and Alert Generator 110 for incorporation into the stand determination and alert system. For example, a user may enter a period of time in which a particular field will be analyzed, details concerning manure applications, or observations made when planting or harvesting that may be incorporated into the Stand Analyzer and Alert Generator 110. On some occasions, manually selected preferences and other user-entered information may be stored in Database 135.

The Stand Analyzer and Alert Generator 110 provides information about determined stand statuses to User 130. This may be done in a variety of ways, including through the use of an e-mail and/or a message relayed via a messaging system accessible through Communication Network 105 that includes hyperlinks to a portal at which details regarding the stand determination are available. Other forms of communication, such as an instant message or a text message sent via short message service (SMS) to a user's mobile phone may also be used to indicate a stand deficiency has occurred. In FIG. 1, User Interface 125 is meant to represent any device via which User 130 can be provided with information regarding the stand status determination. Exemplary User Interfaces 125 include desktop or laptop computer systems, mobile computing devices (including but not limited to so-called “smart phones”), tablet computing devices, and portable computing devices.

In some embodiments, one or more Users 130 may be enabled to access a stand determination analysis via User Interface 125 communicatively coupled to Network 105. Interfaces for various types of users may be different in form and content, or similar to User Interface 125. Exemplary users include employees, managers, owners, equipment operators, suppliers, consultants, regulators, and others who assist User 130 in determining and/or executing a corrective strategy or have an interest in the status or outcome, anticipated and realized.

FIG. 2 is a block diagram depicting exemplary sets of data or databases that may be included in Database 135. For example, Database 135 may include Field Data 205, Climate and Weather Data 210, Local Knowledge Data 215, Geologic/Geographic Data 220, Planned and Executed Event Data 225, Supplier Data 230, Buyer Data 235, Landlord Data 240, Crop Data 245, and Trigger and Alert Data 250. Information stored in Database 135 may be received from, for example, a user, such as User 130, a Data Feed, such as Data Feed 115, an In-season Data Gathering Source, such as In-season Data Gathering Source 140, via a communication network, such as Communication Network 105, and/or a combination of the foregoing.

Field Data 205 may include information regarding, for example, field locations, the shape of the field, the proximity of the field to other relevant locations such as other fields managed and operated by the user. In this embodiment, field data may include field data for other farmers' fields. It may also include the field's characteristics, such as topographical information, soil types, organic matter, moisture condition and water-carrying capacity, fertility, and other non-crop vegetation on the field. In addition, Field Data 205 may include historical crop production data on the field, including crops planted in prior years and historical yields, including yield maps illustrating yield variability across the field, as-planted maps, and tile maps. In addition, Field Data 205 may include historical practices specific to that field, including for example, tillage and irrigation.

Climate and Weather Data 210 may include information relating to historical and predicted weather and/or climate conditions for a particular region, area, or field. For example, rainfall, hail, wind, and other factors that may impact stand.

Local Knowledge Data 215 may include information relating to knowledge or preferences specific to a user and may include, for example, preferred agronomic and other crop production practices, site-specific knowledge, past experiences, activities, observations, and outcomes. On some occasions, Local Knowledge Data 215 may be used to override or modify an aspect of a stand determination analysis. On some occasions, Local Knowledge Data 215 may include data received via a social network from other users. For example, stand problems on a nearby field operated by another farmer may be relevant to the user's fields; i.e., cutworm on one field is possibly an indicator of a stand problem on another field, or hail on a neighboring field may be an indicator of a stand problem on the user's fields.

Geographic/Geologic Data 220 may include geographic and/or geologic data related to, for example, fields which are included in the determination, analysis, and alerts. Exemplary geographic or geologic data may include roadway, surface and/or underground water, and landmark locations. Geographic/Geologic Data 220 may be derived from a variety of sources, such as satellite images, global positioning information, historical information regarding an area of land, plat book service providers, non-governmental organizations, and public and private organizations and agencies.

Planned Event Data 225 may include information regarding planned events proceeding, during, and/or following the crop-growing season. Exemplary planned events may relate to activities such as when crops are planted and the seed specifications and planting information, such as planted seed locations and population, scouting events, fertility tests, follow-up assessments, scheduled aerial data gathering events, and treatment events.

Supplier Data 230 may include supplier information (names, locations, services, products, prices, contractual information, etc.), as well as delivery and/or instructions, dates and other special activities related to stand determination analysis and alerts.

Buyer Data 235 may include data that relates to obligations and specifications that a buyer of an agricultural crop may have imposed on the farmer that impact the stand determination analysis and status, such as, for example, restrictions, response requirements, standards, notifications, schedules, requirements, and the like.

Landlord Data 240 may include data that relates to obligations and specifications that a landlord may have imposed on the farmer that impact the stand determination, such as, for example, restrictions, response requirements, standards, notifications, schedules, requirements, and the like.

Crop Data 245 may include crop conditions over the growing season as determined through various sensing methods, such as through UAVs or visual observations, and through the user's local knowledge. It may include previously performed analyses and determinations of stand.

Trigger and Alert Data 250 may include specific measurement parameters which, if exceeded, cause an alert to be triggered and sent to the user. In the present embodiment, the triggers are preset to defaults by the stand analyzer and alert system. However, the user can override the default triggers on a field and/or operational level if he or she feels the need to do so. Additional data in this database may include historical determinations and alerts that have been previously sent to the user.

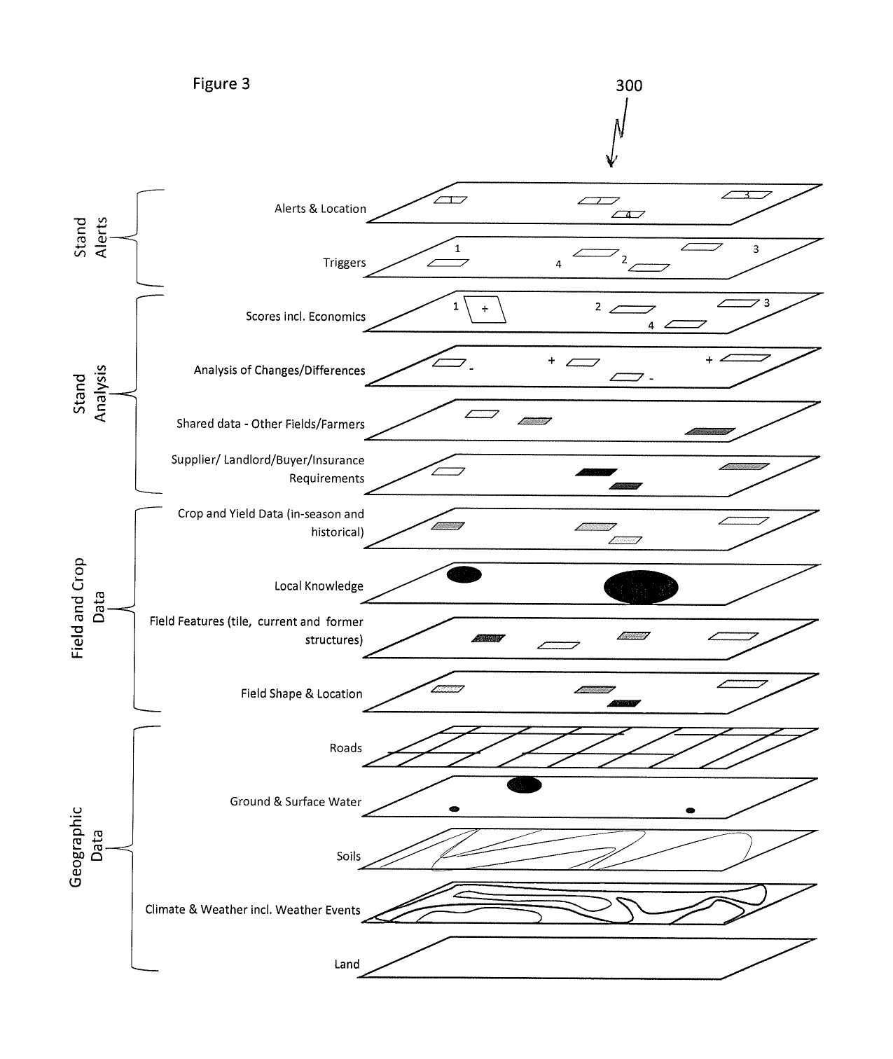

On some occasions, the Geographic and/or Geologic Data 220 may be part of a geographic information system (GIS), an example of which is illustrated in FIG. 3. As shown, GIS Layers Image 300 includes various data structures, each of which may be regarded as a layer. These layers provide information regarding various data elements of a stand analysis and alert for a field, including, for example, geographic data, field and crop data, stand analysis data, and stand alert data.

Exemplary geographic data may include, for example, information related to an area of land (the field plus adjacent areas) (e.g., topography, slope, etc.), historical weather and climate information, soil attributes (e.g., soil types, texture, organic matter, fertility test results, etc.), the presence and location of ground and surface water, and any man-made features upon the land (e.g., buildings, roads, ditches, etc.) currently existing or formerly in existence. Exemplary field and crop data may include the location, size, and shape of the field, and may be related to tiling information. Exemplary local knowledge may include special insights concerning the field that only the person farming the field would know. It may also include comments and data related to special events and visual observations. Historical crop and outcome data may be former crops planted and yields, fertility tests, fertilizer applications, and other applied products. Exemplary stand determination analysis may be requirements imposed on the farmer by the landlord or buyer of the crop and/or instructions and contracts with the supplier of crop inputs and services. It may also include data that relates to insuring the crop. It may also include data shared from other farmers, and determined stand status scores, including economic viability concerning replanting areas of stand deficiency. Stand determination alerts data may be those issued alerts that are stored in Database 135.

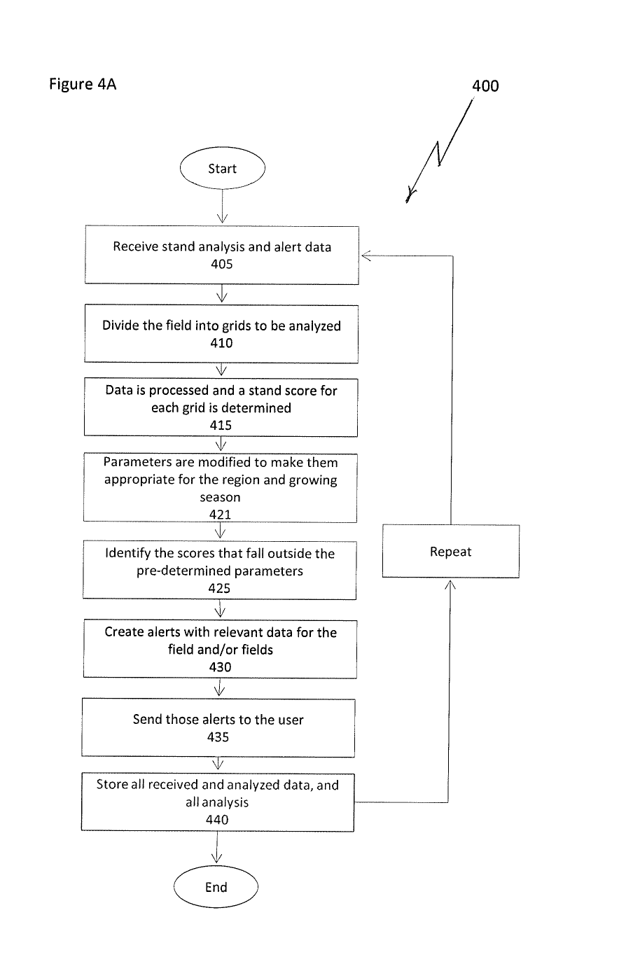

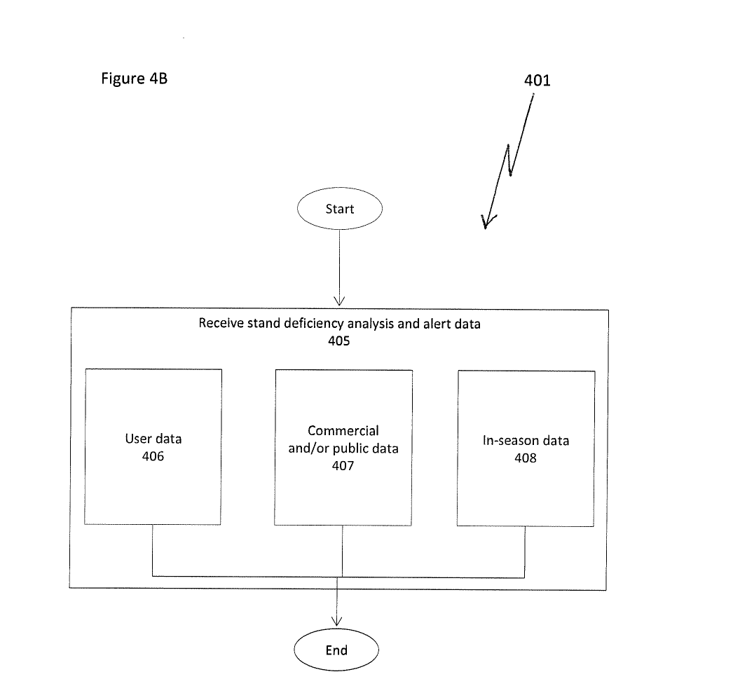

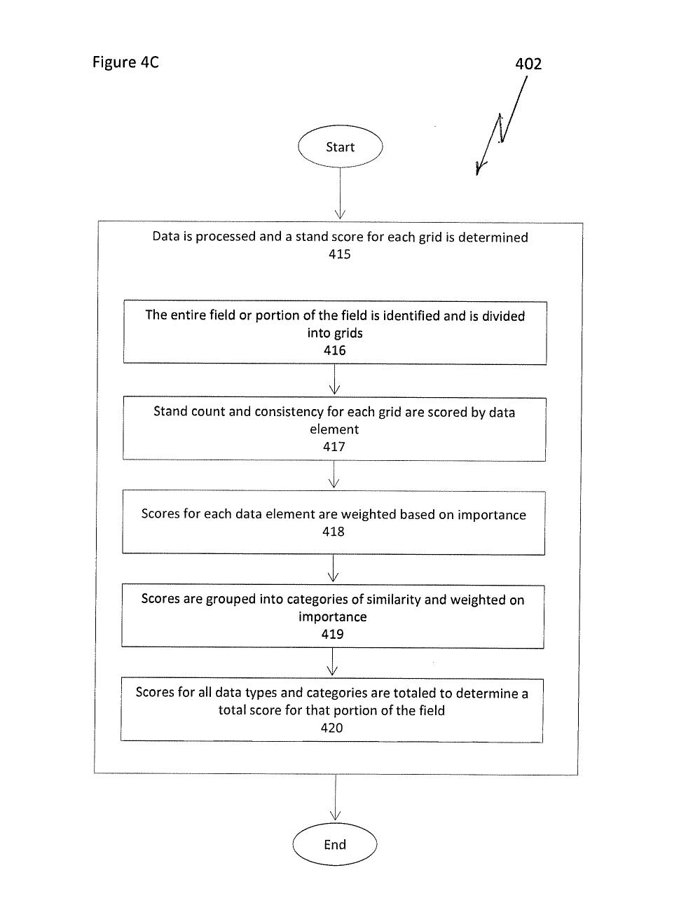

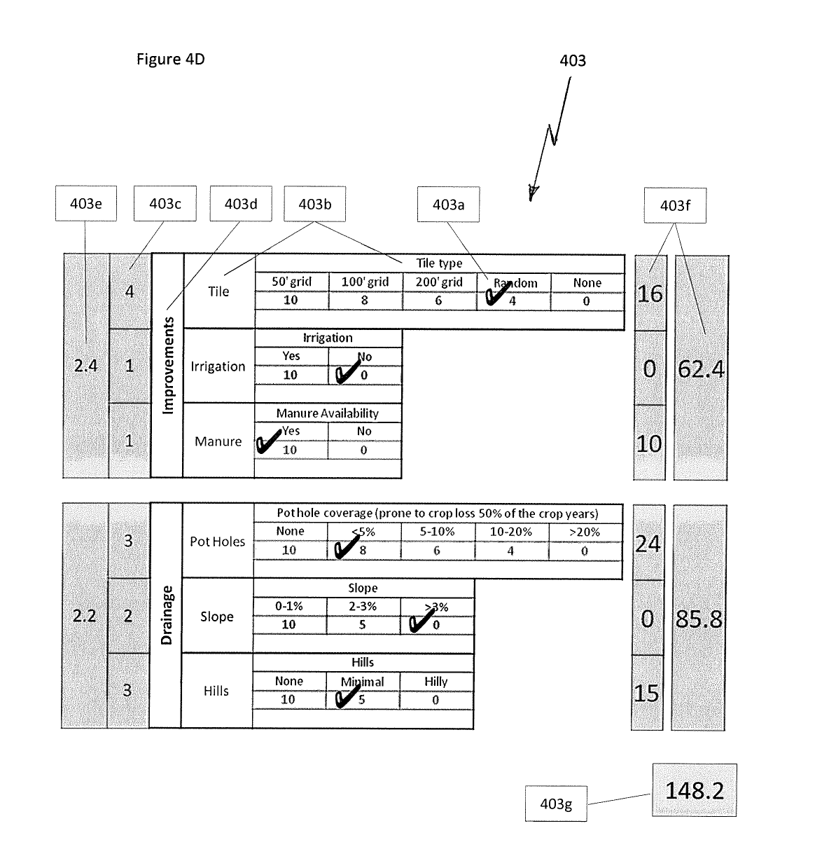

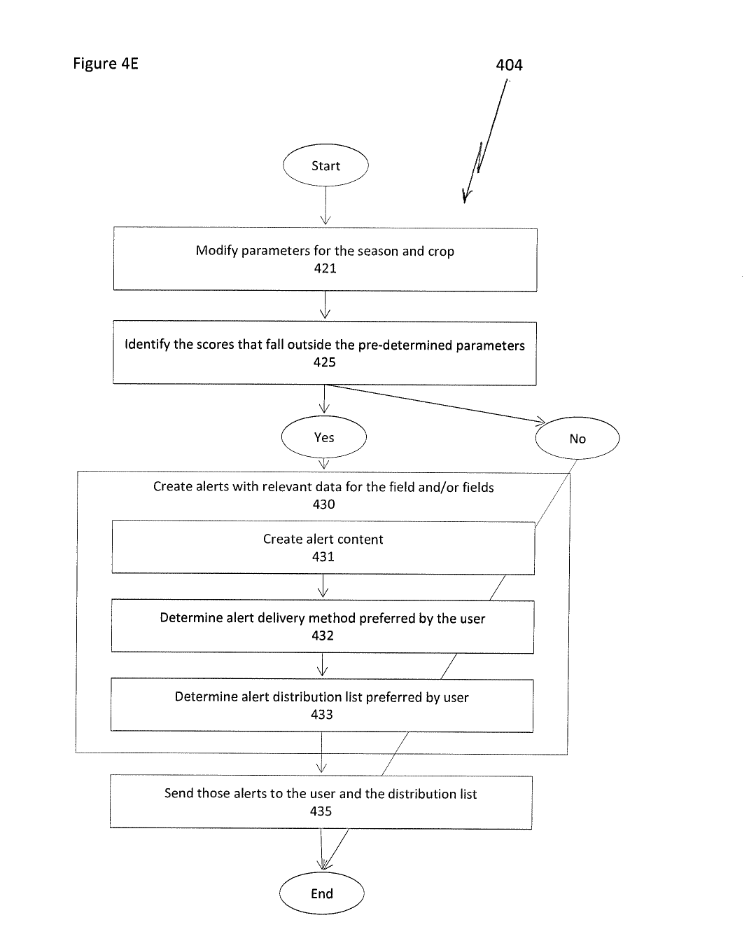

FIG. 4A is a flow chart depicting an exemplary process 400 for generating a stand determination alert in accordance with an embodiment of the present invention. Process 400 may be executed by the Stand Analyzer and Alert Generator 110 described in connection with FIG. 1 in cooperation with, for example, any of the systems and/or system components disclosed herein.

In step 405, information regarding stand determination may be received by, for example, Stand Analyzer and Alert Generator 110 from, for example, a user, such as User 130 (via a user interface, such as User Interface 125), a database, such as Database 135, a data feed, such as Data Feed 115, and an in-season data gatherer, such as In-season Data Gatherer 140, via a communication network, such as Communication Network 105. Exemplary received information may relate to target areas for the stand determination and alert system, a UAV event and the data generated, an in-field sensor, commercial and/or public data, and/or data entered by a user based on a visual inspection. Additional examples include disease or pest information that impacts stand status from a public or social network, hail, rain, or other weather event, planned events, local knowledge, historical patterns, scientific research, and/or geologic/geographic characteristics of target areas. On some occasions, the received information in step 405 may include one or more previously generated stand determination analyses. The target area may be divided into grids where the grid size is based on the input of the user or determined by the Stand Analyzer and Alert Generator (step 410). Grid sizes may vary from a few square feet to one or more acres. The smaller the grid the more accurately the Stand Analyzer and Alert Generator will determine the stand for that specific grid. The new data may then be processed and analyzed in combination with other data to determine a stand score for each grid (step 415).

When the stand analysis is performed by the Stand Analyzer and Alert Generator 110, the results are then analyzed against predefined triggers. It is important to point out that the triggers for the Stand Analyzer and Alert Generator 110 change depending on the time of year, the type of crop, and the stage of the crop in its growth cycle. For example, early in the growing season the triggers may be at a level such that the user is notified with a higher sensitivity to stand deficiency because replanting certain areas in the field may be a viable option if deficient stand population and consistency are discovered early. Later in the season replanting is not a viable option because any replanted crops may not have time to mature in the remaining growing season. This example is reflective of more northern farming areas where the growing season (summer) is shorter in duration relative to other climates. The final replant decision is based on multiple factors, including the time of the year, the financial costs of replanting or not, insurance terms, and contractual obligations with the farmer's landlord or buyer of the crop. Therefore, scores and/or triggers are modified (step 421) to reflect the changing crop options during the course of the year.

The scores for each grid may then be analyzed against predefined acceptability parameters (step 425), and if they fall outside those parameters, they trigger the stand determination and alert system to notify the user. If a trigger is activated, the Stand Analyzer and Alert Generator 110 creates the appropriate alert (step 430) and notifies the user using the preferred communication method as defined by the user (step 435). Finally, that data, both received and the analysis resulting from it, is stored within the Database 135 (step 440).

FIG. 4B is a flow chart depicting exemplary process 401 for receiving stand determination analyzer and alert data in the flow chart of FIG. 4A with regard to step 405. Process 401 may be executed by the stand determination and alert system described in connection with FIG. 1 in cooperation with, for example, any of the systems and/or system components disclosed herein.

In step 405, new data has been received by the stand determination and alert system and analyzed. For the present document, exemplary new data is entered or received from three primary sources: the user (block 406), commercial and/or public sources (block 407), often, but not always, accessed through the Internet, and in-season data gathering sources (block 408) that reflect in-season crop status such as the data produced by a UAV or an in-field sensor. In step 406, the user enters into the Stand Analyzer and Alert Generator 110 any information that relates to his or her field(s), crop(s), including planted seed and as-planted data, local knowledge, local observations, planned events, and supplier, buyer, and landlord data. In step 407, the Stand Analyzer and Alert Generator 110 searches for and receives data from the System Database 135 and data from free and fee-based sources (commercial and/or publicly available data) that relates to geographic data, climate/weather data, and economic data including pricing and agronomic data. In step 408, the Stand Analyzer and Alert Generator 110 receives data reflecting the current status of the crop from a UAV (or other in-season data-gathering device) after its flight.

FIG. 4C is a flow chart depicting exemplary process 402 for analyzing the received stand determination data with regard to step 415 shown in FIG. 4A. After the stand determination data is received by the Stand Analyzer and Alert Generator 110, the field or a portion of the field is identified by the system and then divided into grids for analysis (step 416). In some scenarios, the user may decide that only a portion of a field will be analyzed; for example in the case of a troublesome part of the field. It is understood that across a field the stand may be variable due to a number of factors, for example field topography including hills, slopes and low areas, tile placement, soils texture, planting equipment malfunctions, and variable levels of rain, hail, and wind, as well as a variety of other factors. The grids provide a method to determine stand for each portion of the field independently of the other portions of the field. In some scenarios, only one grid may indicate a stand issue while all other grids indicate normal stand condition. However, issues with one grid may be an early indicator of widespread stand issues to follow. The size of the grids will vary from one user to another and one field to another depending on the user's preferences. For example, a user who has a field with greater variability may use smaller grids to accurately analyze the field. The size of the grids are determined by the user in this embodiment, however it is anticipated that the grid sizes will typically vary from acres to square feet, depending on the visual data source and user preferences.

Data is then analyzed for each grid (steps 417, 418, and 419). This analysis may include image processing and data analysis, in combination with observations and local knowledge entered by the user. Of course the types and scope of the analysis may vary depending on the crop, time of year, latitude and longitude, and the specific data elements on which the user wants to focus.

In the present embodiment, each grid is scored by data element (step 417). There may be multiple degrees or levels of factors that impact stand for each data element; for example: type of tile, such as 50′ grid, 100′ grid, 200′ grid, random, or none. Each of these types of tile may impact stand by various degrees and therefore a value is assigned. The data element will then have a value related to the type and existence of tile in the grid. It should be noted that tile and the ability to remove excess rain may be a significant factor in scoring stand. Other data elements may only have a simple yes or no response option. Another exemplary data element may be the imagery captured by the UAV. In the present embodiment, the imagery is of such high quality that the stand can be counted and the consistency scored. In other embodiments, samples of a field may be used and total stand estimated. The Stand Analyzer and Alert Generator 110 will continue to analyze each of the data elements for each grid and assign a score to them. Each of the scores is then modified based on weighting (step 418) for that individual data element. For example, an actual stand count resulting from a UAV event that was recently received would carry higher weighting than data related to tile, topography, or soils, etc.

In the present embodiment, the data elements are grouped together with other similar data elements into categories (step 419). For example, a soils category may contain soil texture, soil variability, soil organic matter, and the like. The scores for each category are then totaled and modified based on weighting for that category (step 420). All categories are totaled to arrive at a score for that portion of the field.

FIG. 4D is an exemplary table demonstrating a method to arrive at a score for each grid of a field (step 415). In the present embodiment, the data elements are assigned response options with corresponding values for each response option (403a). The data elements are grouped together in categories of similarity (403b). In addition, each data element is assigned a particular weighting of importance within its category to place the appropriate amount of emphasis on each data element (403c). The categories of data elements (403d) are also assigned a particular weighting overall against other categories (403e). These response option values, weighted according to ranking of importance, both within each data element and within its category (403f), are then summed to create a final stand score (403g). In the present embodiment, two categories are listed, Improvements and Drainage. Although the factors and categories may vary according to the type of crop, the area the crop is planted on, the farmer's preferences, etc., some potential categories of consideration include, crop stress, fertility added, soils, drainage, improvements, weather's impact on nutrient availability, management practices, production history, and seed-as-planted.

FIG. 4E is a flow chart depicting an exemplary process 404 for notifying the user of stand determination with regard to steps 421, 425, 430, and 435. Notifying users of changes in stand determination begins after each grid has been analyzed and a score of stand determination has been determined. The scores for the grids that are included in the analysis are compared against the parameters of acceptability for the particular crop and the particular season. The parameters are modified throughout the season depending on the type of crops planted and the time of the year (step 421). If the scores exceed the parameters, then a notification to be sent to the user is triggered (step 425); if not, then no notification is sent. Those scores that do not fall outside the parameters are stored as data in Database 135, but no other action is taken and process 404 ends. Exemplary parameters may include scores that indicate an unexpected change in normal and customary plant growth, an indication that the crop stand is deteriorating by a pre-defined measure, or a defined minimum number of grids, acres, or percent of the field that has demonstrated an indication of stand issues. If an alert is triggered, then the stand deficiency parameters have been exceeded and a notice will be sent to the user (step 430).

In step 430, the alert content is automatically created by the stand analyzer and alert generator (step 431). Exemplary content to be included in the message are the reason for the alert, the date and condition of the last data sample, the location(s) of the determined change in stand, the number of grids excluded from analysis, and the number of grids or acres determined to have activated the trigger of an alert. Of course the actual content will depend on the embodiment and can differ for many reasons including, for example, the preference of the user, type of crop, or severity of the stand issues. Another example of message content is a simple notification to “check a field” or maintain surveillance on a field on a “watch list” with little specificity as to the severity of the stand deficiency. In some embodiments the content of the notification may differ based on the role of the individual. For example, a supplier may receive a message with information that differs from a message received by a peer farmer included on the distribution list.

The Stand Analyzer and Alert Generator 110 then determines the method by which the user prefers to receive the notification (step 432) and the list of people who will also receive the notification list (step 433), identified as the distribution list in the present document. The user may elect to receive the notification by any number of methods or combination of methods; for example, via a text message or email, and/or phone call. The user may create a distribution list that identifies the individuals or organizations that should know about the stand or those who may be helpful and could take action to quickly remedy the stand deficiencies. Examples of people who a user may want to include in a distribution list are him- or herself, a farm manager, consultant, supplier, buyer, landlord, peer farmer, and/or banker. The user may notify those included on the distribution list by any number of methods or combination of methods; for example, via a text message and/or email (step 435). In some embodiments the user may want to notify other peer farmers using these methods, however, the user may also use a type of social network to provide notifications. Following step 435, process 404 may end.

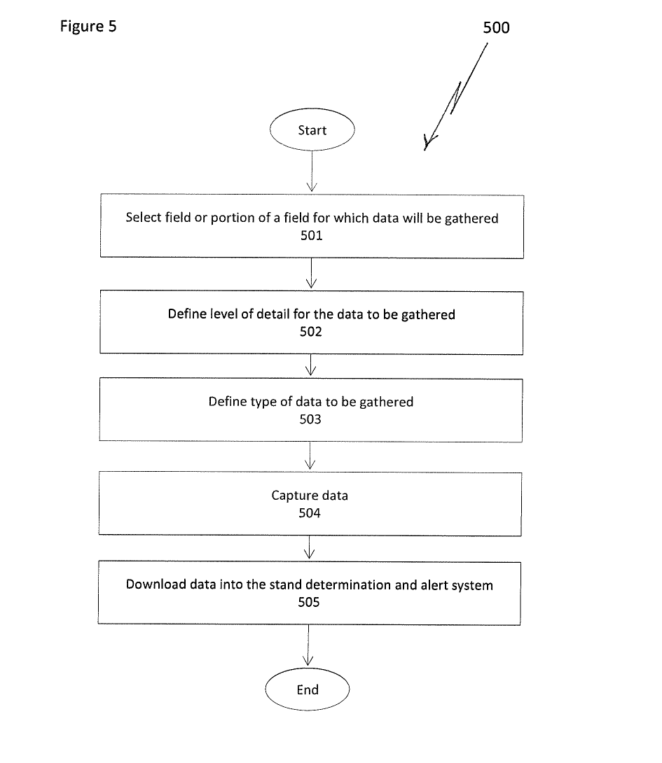

FIG. 5 is a flow chart depicting an exemplary process 500 for gathering in-season imagery of plant conditions with regard to step 405 of FIG. 4A. As previously described herein, an important aspect to the present invention is the ability to identify stand issues as soon as possible such that corrective action can be taken and the deficiency rectified so that crop deterioration and yield loss is minimized. In the present embodiment, UAVs are the preferred method by which to gather data, however other sources, such as manned aircrafts, satellites, and in-field and remote sensors may also be used. The present document will not define controlling the manned or unmanned aircrafts. Likewise, the present document will not define the type of images used. These technologies are well-documented and while used by the Stand Analyzer and Alert Generator 110, they are not the subject of the present invention. This invention will focus on the aspects related to determining stand and alerting designated parties of stand issues and deficiencies.

Process 500 begins with the selection of the field or portions of a field from which data will be gathered (step 501). Exemplary data regarding the areas to be analyzed may include latitude and longitude, shapes, soils, slopes, topography, historical data, weather, crop, practices, and GIS data. The Stand Analyzer and Alert Generator 110 will use this data and combine it with other data available for that area.

The user may decide to gather data for an entire field or only a portion of a field. In the event the user makes the decision to gather data for only a portion of a field, he or she will then define the boundary of that portion (step 501) of the field in question. The user will then decide the level of detail (step 502) for the information he or she wants to gather. As described earlier, the level of detail may be in grids that are in various sizes as determined by the user. The user may then enter the type of data to be gathered (step 503). The data-capture device (i.e., a camera attached to the UAV) then captures the data (step 504), and the data is then downloaded into the stand analyzer and alert system database 135 (step 505). Exemplary methods to extract and download data from the capture device to the database may be via a memory stick or other memory card or a wireless transfer directly from the device to the database.

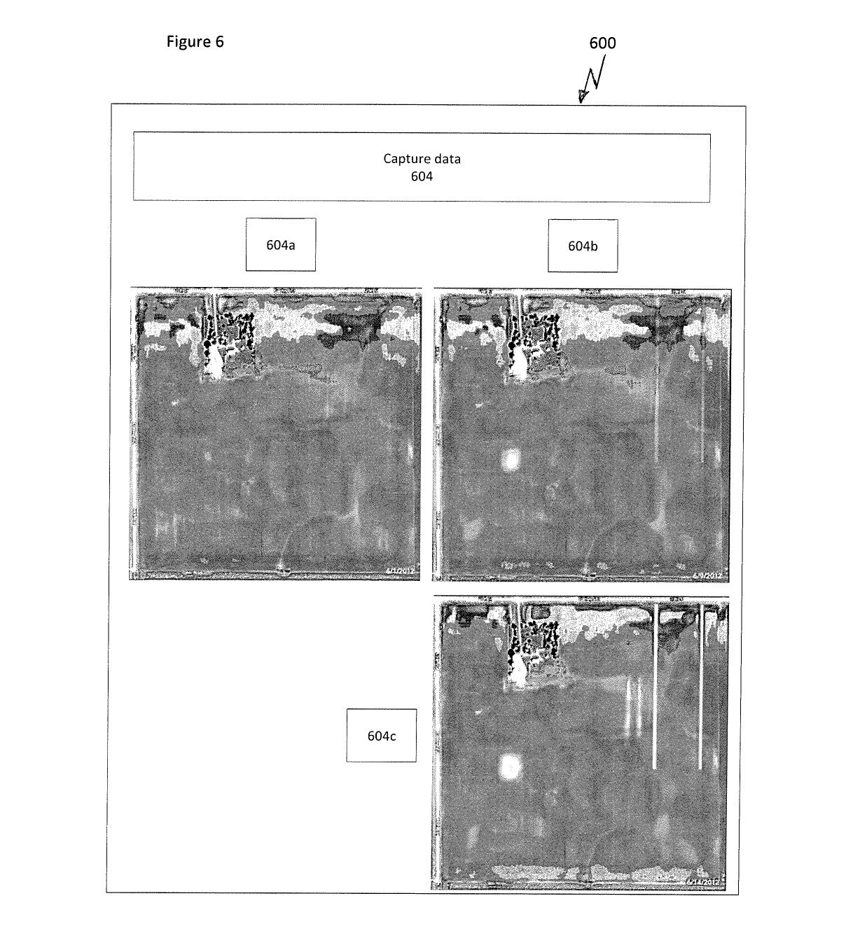

FIGS. 6-15 illustrate various aspects of graphical user interface (GUI) screens that may be used to gather and/or present information regarding stand determination and alert users of a stand deficiency or issue in accordance with embodiments of the present invention. The GUIs shown in FIGS. 6-15 may be prepared by, for example, Stand Analyzer and Alert Generator 110 and provided to a user, such as User 130 via an interface, such as User Interface 125. FIGS. 6-15 illustrate exemplary GUIs that relate to a user who is receiving alerts, gathering data, reviewing information, and managing crop development, and demonstrate the use of a “smart phone,” tablet-style computer, and/or PC as well as email and text messages, as user interface 125.

FIG. 6 contains three images of a field captured by a UAV over a period of days and illustrates changes in the crop's condition over time (604a, 604b, and 604c). In this embodiment the images and related data, captured over time, is analyzed and the stand status is determined. As previously described, the stand status is measured, for example, based on texture, color (traditional and infrared), patterns, tone, shadows, and temperature combined with other available data and is the basis for generating a score of stand status by the Stand Analyzer and Alert Generator 110. These images are just indicative of the type of image data that the Stand Analyzer and Alert Generator will receive. As computerized image comparisons have been well-developed, the present invention uses those techniques to analyze and determine stand deficiencies and issue immediate status alerts if necessary.

In some embodiments, certain visual and other display techniques may be used to make the stand deficiencies more obvious. One method used may be to amplify the visual indicators of the crop's growth by electronic means to enhance the image and illustrate any deficiencies in a more obvious manner. Another method is through the use of time-lapse where changing crop conditions can be visually observed over time.

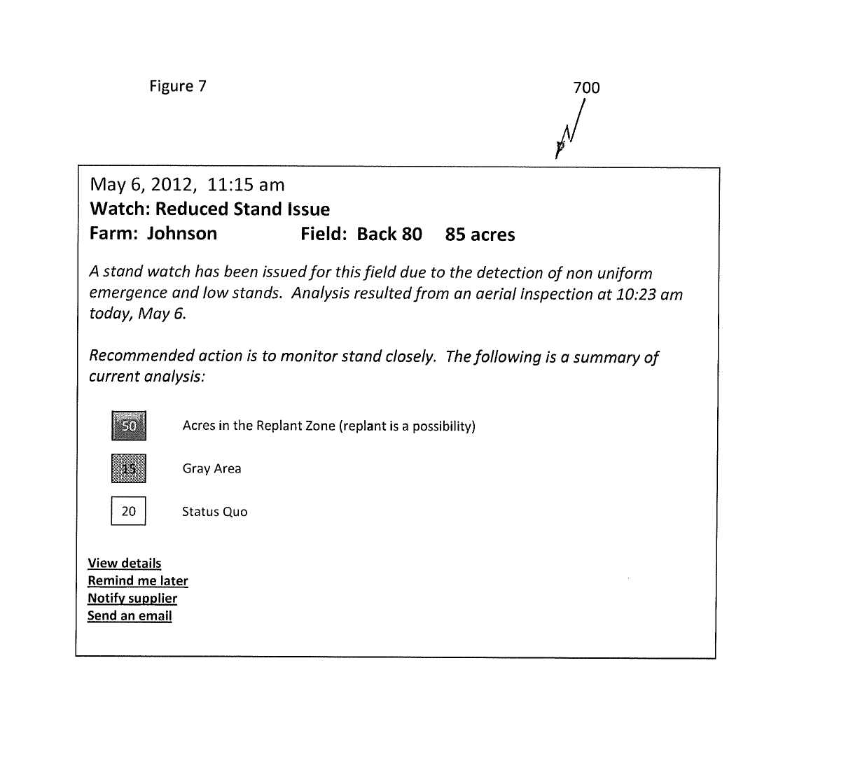

FIG. 7 shows an example of an alert message that the user may receive in response to a determined stand deficiency. This exemplary message alerts the user that a stand deficiency has been determined by the Stand Analyzer and Alert Generator 110 and in this embodiment the user is advised that he or she may want to personally investigate/inspect the location of the deficiency to make a final determination. The user may be the farmer or another person designated by the user to receive the information, such as a crop consultant, buyer, supplier, landlord, or other designated person or organization. In this example, new additional data was received by the Stand Analyzer and Alert Generator 110. As stated on the alert the data-gathering event occurred at 10:23 am. It is important to point out that an essential aspect of this invention is the ability to process new, in-season data and generate user alerts in a time-frame that allows the user to take corrective action quickly and thereby minimize damage to the crop. In this example, the data-gathering was completed by a UAV that captured the data approximately an hour before the alert was sent to the user. This additional, new, in-season data, combined with data already contained within Database 135, was then processed by the Stand Analyzer and Alert System 110 to determine a stand score. In this example, the stand score triggered an alert; 50 acres have a stand deficiency and replanting may be the recommended prescription, 15 acres are in a “gray area” where the farmer needs to determine the best course of action if any, and 20 acres are within acceptable parameters (status quo) and no corrective action is needed at this time. When the score exceeded the predefined parameters of acceptability, it triggered the Stand Analyzer and Alert Generator 110 to automatically generate an alert and send it to the appropriate user and/or those authorized by the user to receive the alert via Communication Network 105. The alerts may contain various levels of detail, such as the size and/or location of the area/grids where the analysis was performed and deficiencies found. The alert may also contain content that is unique, based on the preferences or roles of the user.

While the use of a UAV is the preferred method to generate additional new, in-season, aerial data, it is only one type of device that could be used. For example, an in-field or remote sensor, a rain monitoring device, and/or a weather forecast may all cause the Stand Analyzer and Alert Generator 110 to determine that an alert is required.

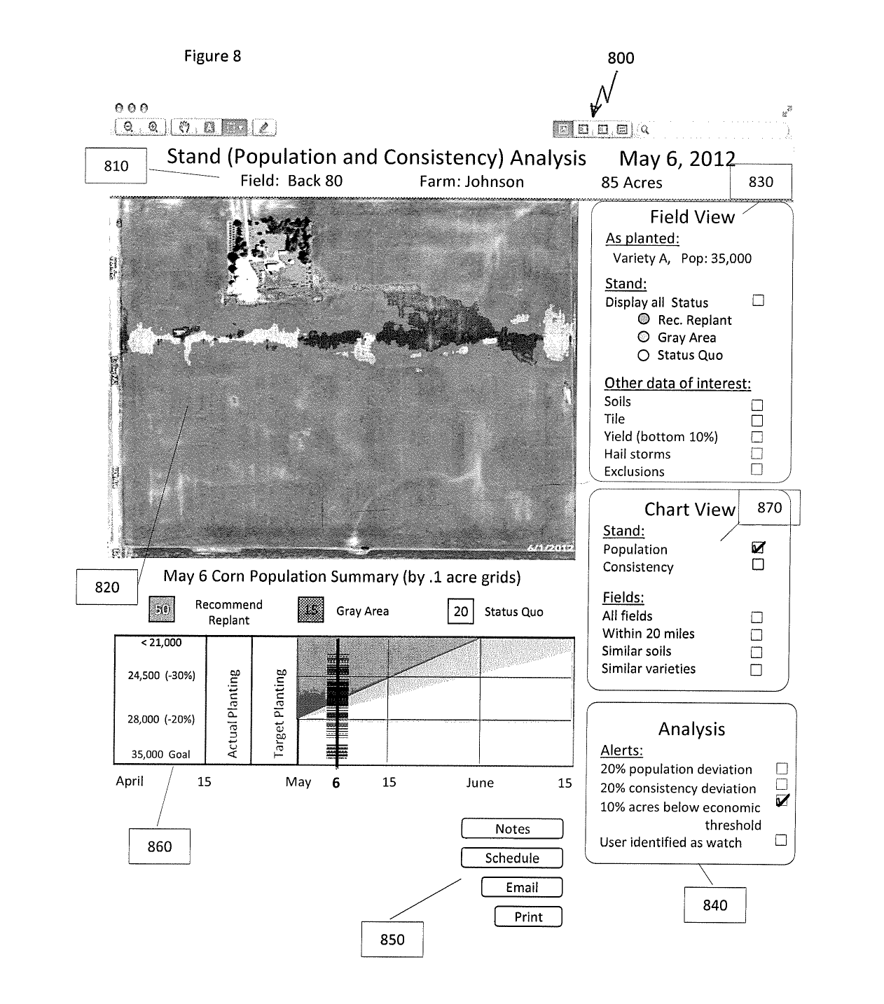

FIG. 8 illustrates an example of a user interface that may be used by a user to review information related to stand determination. In this embodiment, an alert has been triggered and the user has been notified of a potential stand problem on this field. However, in this embodiment the user can access this information regardless of whether or not an alert has been triggered. It should also be pointed out that the content on this screen may vary depending on the role of the user and the presentation of the content may vary depending on the manner in which it is viewed.

Screen 800 provides a user with information regarding stand determination for a specific field along with additional information that may be helpful to the user. In this example, field identifiers 810 as well as an image of the field 820 are provided. Along with the field image 820, there is a modifiable field view area 830 that contains controls that allow the user to alter the views of the field 820, in addition to the ability to exclude areas of the field that are not to be included in the analysis. An analysis area 840 is also provided and identifies the alert status and the triggers, or sensitivity parameters, which, if activated, result in an alert. The ability to take actions regarding the issued alert 850 is also provided. This screen shows a graphical chart 860 that can show trends in stand determination over time. Finally, chart view 870 enables the user to change the view of the content contained in the chart 860.

Screen 800 contains field identifiers 810. In this embodiment the field and farm names are displayed, as well as the acreage. Other possible content for this portion of the screen may include latitude and longitude, crop type, and/or ownership status.

In exemplary screen 800 there is an image of the field 820. In this example, the image is the result of a UAV and an in-season data gathering event. While not shown on this sample screen, it is understood that various types of information may be available to the user by moving a cursor over the image. For example, displaying consecutively multiple images taken over time, gives the user a view of the changes in crop stand over time. In some embodiments, the user may be able to zoom in on part of a field and thereby gain a closer view. In some embodiments, the views available may depend on the capabilities of the user interface device, on the capabilities of the UAV capturing the data, and on the transmission capabilities of the Communication Network 105.

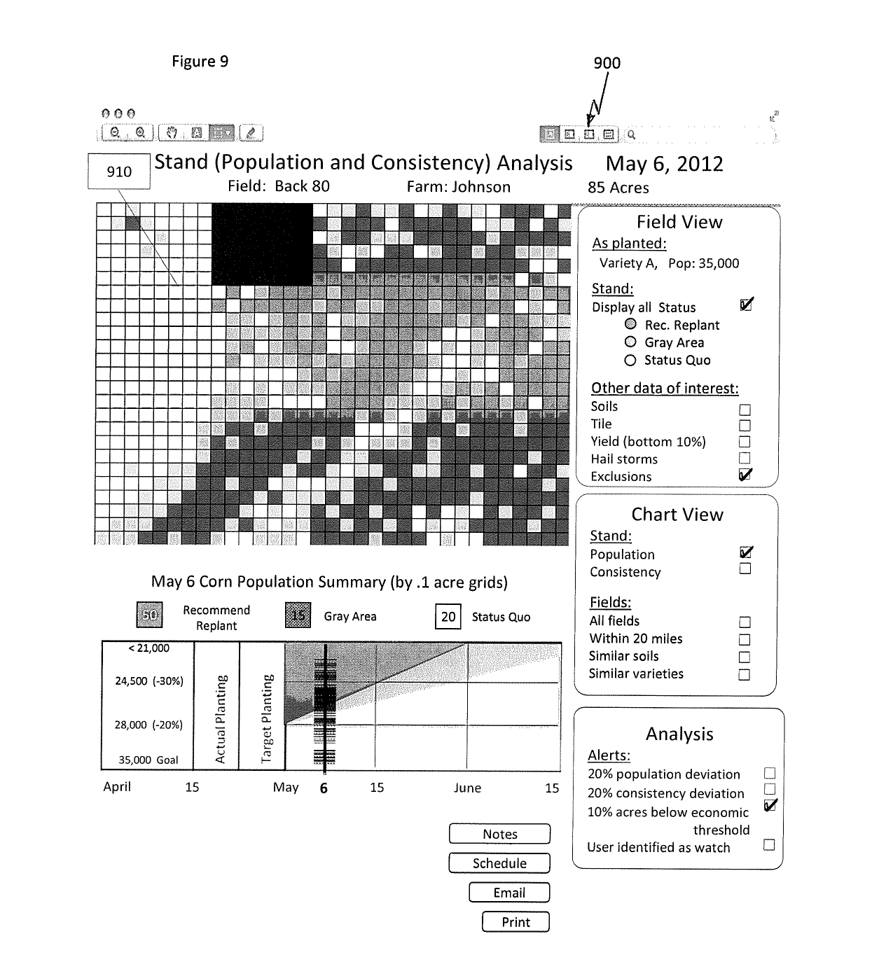

The modifiable field view area 830 enables the user to control the content displayed on the field image 820. In this exemplary embodiment, the user can overlay information relating to the soils, tile, yield, weather, and exclusions onto the field image 820. This additional information may change the way the user views and interprets the data. The exclusion portion of the field view 830 of this exemplary user interface relates to portions of the field that will be excluded from analysis and alerts. The purpose of this capability is because a user may wish to use his or her own local knowledge and exclude those portions of the data that would naturally deviate from the data received for the intended area to be analyzed and throw off the data set. For example, the user may want to exclude former building sites from the analysis because they may skew the results. The Stand Analyzer and Alert Generator 110 uses this method to prevent needless and unnecessary alerts from being sent to the user. Each of the view types list in the field view 830 will aid the user in making determinations of what follow-up actions, if any, he or she may want to take. See FIG. 9 for an example of a variant field view display.

Analysis area 840 contains a summary of the alert analysis, as well as identifies the triggers which will cause an alert to be sent to the user. Here, the user is able to identify the parameters, which if exceeded, will trigger an alert to be sent to the user via the Communication Network. For example, the user can request to receive an alert when a certain amount of a field or a certain percentage of deficiency has been shown to have stand issues. For example, the system could send an alert when the portions of the field are identified as having at least a 20% deviation in population compared to the rest of the field as determined by the Stand Analyzer and Alert Generator 110. The check mark indicates that that parameter has been selected. Specifically, the user would like to be issued an alert if at least 10% of the field has been identified as being below the economic threshold. Of course, there may be multiple ways for the Stand Analyzer and Alert Generator 110 to handle these user-defined triggers. Examples of different approaches include sending an alert to the user every day, or each week, or every time additional data is acquired, for example. The user is also able to add or delete triggers.

Capabilities to take actions based on the analysis are, in this example, indicated by the buttons 850 in the lower right portion. For example, it is possible to send an email to a supplier such that they can correct the problem. Or the user may make a note, or schedule an event, or simply print out a report. Of course there are other actions that some embodiments may have and which would not detract from the intent of the present invention. In addition, specific information relating to the stand determination and potential follow-up actions may be included; for example, the coordinates of the portions of the field with stand issues may be included in an email, as well as other information.

Graphical chart 860 allows the user to view additional types of data and analysis of data concerning stand determination for this specific field. This embodiment includes a graphical method to view each of the grids of data in comparison with each other. In this example, the black horizontal dashes represent a grid from the field and its stand consistency and population. The bottom of the chart consists of a timeline upon which various data gathering events and analyses will be displayed. In this example, a UAV has gathered data on May 6th, and it has been analyzed on a grid-by-grid basis and graphed vertically. In the example shown, the data is superimposed upon a graph that displays the diminishing return further into the growing season to replant particular grids. As is shown in the graph, early in the growing here (in this embodiment, the month of May), it is more economically viable to replant areas where there is a stand deficiency. This replanting option is demonstrated here as a dark gray. As the growing season progresses, it becomes less viable to replant areas; in the present document this is referred to and displayed as a “gray area”. The gray area is where the decision to replant areas of stand deficiency could be decided either way. Finally, the area where the plant growth and stand is deemed appropriate is listed as being “status quo”. Again, as the growing season progresses, even lessened stand success is considered status quo, as the return on investment to replant the affected stand deficiencies is not supported by economic viability. Data gathering events further in the season are shown and discussed below. The determination of when there is a diminished return in the replanting cycle could be based on historical data from this field, or possibly based on available online research by a university or other research organization concerning plant health at specific times in its development cycle.

Finally chart view 870 enables the user to control the view of the data in the graphical chart 860. The user can determine and control what specific data is to be displayed on the chart. He or she can make comparisons with other fields he or she also farms and/or with those fields farmed by peer farmers. The comparison of this field to one farmed by a peer farmer would be contingent on that peer farmer also using the present invention. This sharing of data, as mentioned before, could be communicated via, for example, a social network, or another Internet-based communication method. The user may want to compare this present field to another in proximity to this field because these fields are most likely to be subject to the same weather and growing conditions. In some embodiments, the user may be limited to comparisons to fields that have specific characteristics, such as planting date, varieties, soil types, and farming practices, etc.

FIG. 9 illustrates an exemplary screen 900 further detailing the type of information determined and displayed by the Stand Analyzer and Alert Generator 110. In this example, the content and controls are the same as those described with regard to FIG. 8 and its narrative description except that the grids into which the field is divided for the purpose of data gathering and analysis is displayed in this embodiment and are visually placed on the field map 910. The various sizes and number of grids may be due to the elevation at which the image was taken, or the user may have desired to gather greater detail of data on specific dates, or yet another reason for the various grid sizes may be that the user decided to obtain a data sample for only a portion of the field on a particular day. Also, the black square on the top of the field map indicates that the user has chosen to activate the exclusion layer data, and so this area is now excluded from the analysis. The colors of the various grid squares indicate their stand status, and with their placement on the actual field map 910, trends are easy to identify.

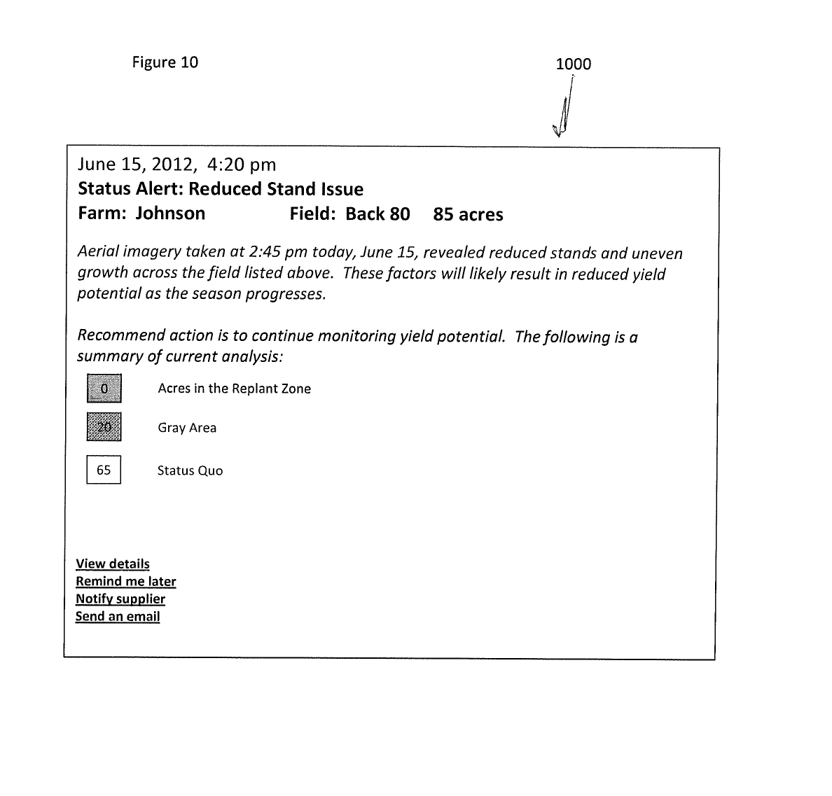

FIG. 10 illustrates exemplary screen 1000 of an alert message that the user may receive in response to a determined stand deficiency. This exemplary message alerts the user that a stand deficiency has been determined by the Stand Analyzer and Alert Generator 110 and in this embodiment the user is advised that he or she should continue monitoring yield potential and use this analysis as a predicting indicator in his or her crop marketing valuations. This alert, sent after aerial imagery gathered on June 15th, reflects that at this late point in the crop-growing season, there are no benefits to replanting stand deficient areas economically, and so monitoring the continued growth and yield potential, and using that information to accurately market his or her crop is the best course of action.

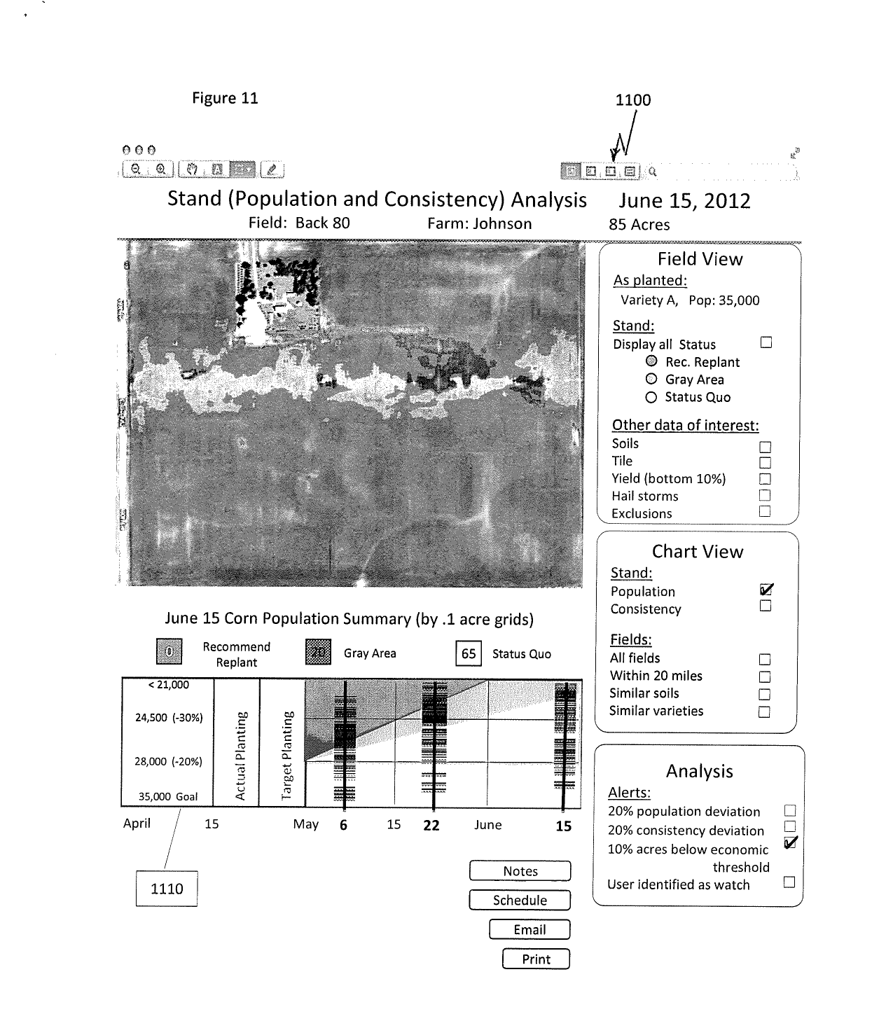

FIG. 11 illustrates an exemplary screen 1100 of a user interface that may be used by a user to review information related to stand determination. In this embodiment, an alert has been triggered and the user has been notified of a potential problem on this field. However, it is understood that the user can access this information regardless of whether or not an alert has been triggered. It is also understood that the content on this screen may vary depending on the role of the user and the presentation of the content may vary depending on the manner in which it is viewed.

Similar to FIG. 8, FIG. 11 provides a user with information regarding stand determination for a specific field along with additional information that may be helpful to the user. In FIG. 11 however, this is the third data gathering event for this particular field, as demonstrated by the graphical chart 1110. This chart indicates that as the growing season has progressed, more and more of the crop is at the status quo level.

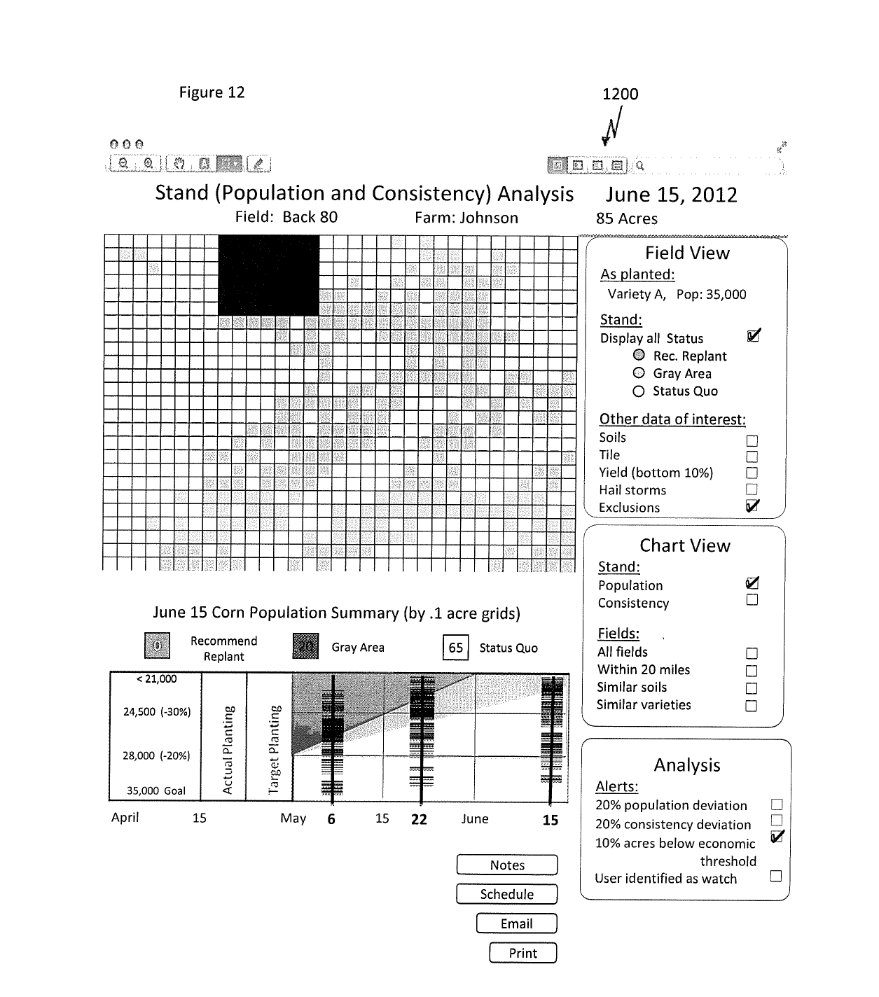

FIG. 12 illustrates an exemplary screen 1200 further detailing the type of information determined and displayed by the stand analyzer and alert generator. In this example, the content and controls are the same as those described with regard to FIG. 11 and its narrative description except that the grids into which the field is divided for the purpose of data gathering and analysis is displayed in this embodiment and are visually placed on the field map.

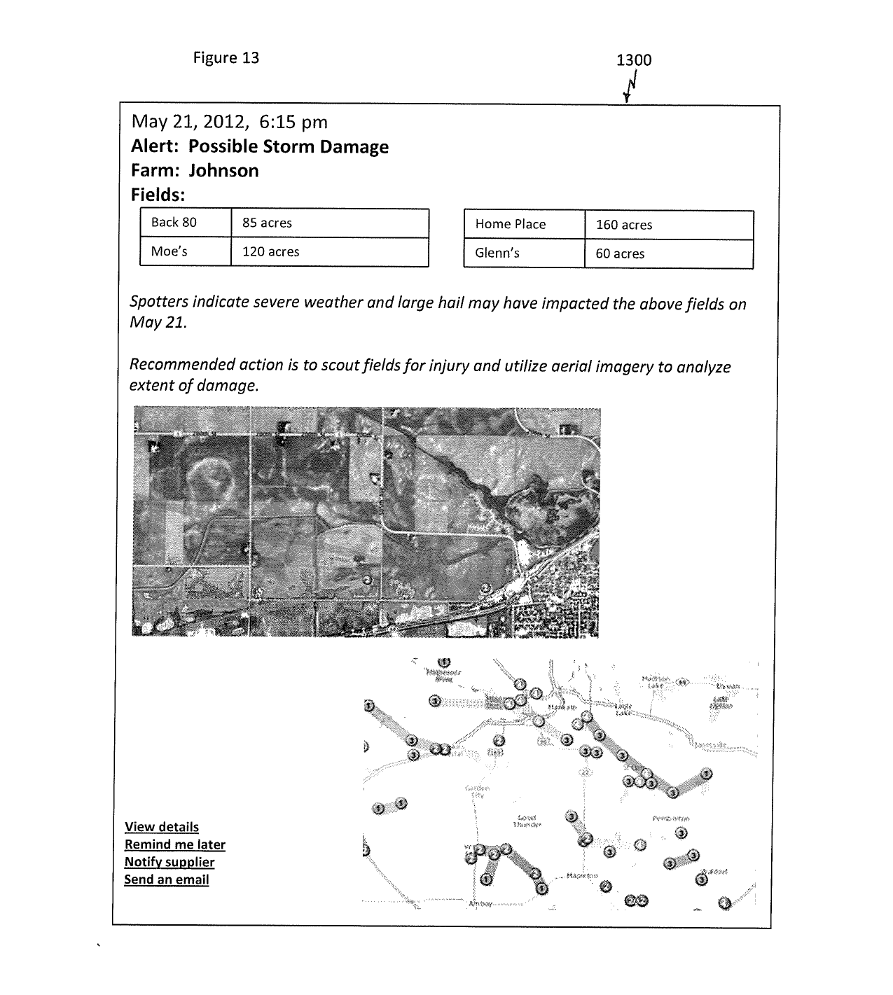

FIG. 13 illustrates an exemplary screen 1300 of an alert message that the user may receive in response to a severe weather event. This exemplary message alerts the user that possible storm damage on four of the user's fields has been determined by the Stand Analyzer and Alert Generator 110. In this embodiment, the alert is issued on May 21 in response to the occurrence of large hail in the area. The user is recommended to scout the fields for injury and utilize aerial imagery to analyze the extent of the damage.

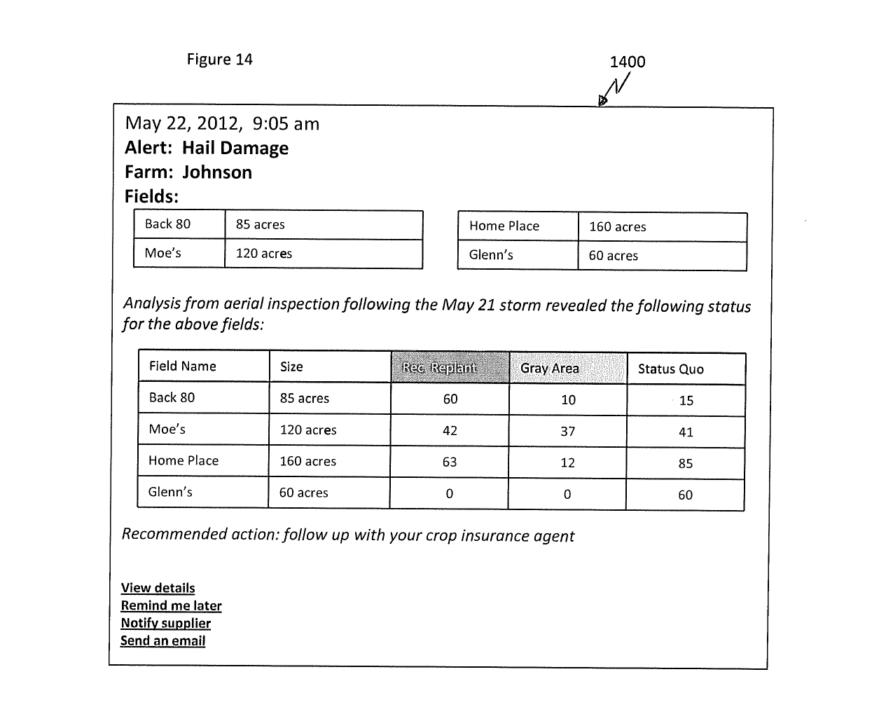

FIG. 14 illustrates an exemplary screen 1400 of an alert message that the user may receive in response to an aerial imagery inspection. In this embodiment, the user used aerial imagery sensors to confirm field injury following the determination that severe weather may have affected the area the previous day (screen 1300). In this embodiment, four of the user's fields are determined to have been in the path of a hail storm, and so the user-requested analysis of these four fields to determine the damage to the crop. The alert message includes a table breaking down the determined stand deficiency for each of the four fields. In this embodiment, three of the four fields have sustained crop damage. The alert message includes a recommendation to contact the user's crop-insurance agent.

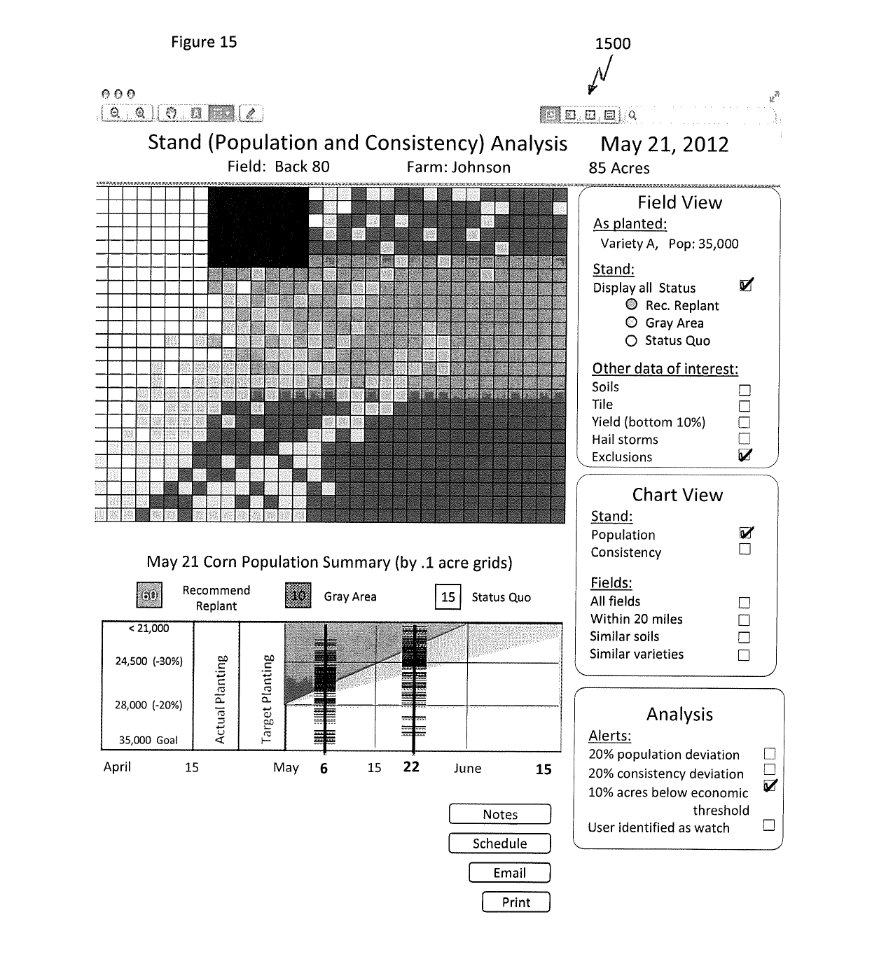

FIG. 15 illustrates an exemplary screen 1500 of a user interface that may be used by a user to review information related to stand determination. In this embodiment, the user sought aerial imagery in response to an alert of a determined hail storm (screen 1300). The aerial imagery of the four fields (screen 1400) determined a stand deficiency. Screen 1500 illustrates the user interface of one of the fields upon which hail damage has been determined. This screen is similar to screens 900 and 1200 in its form and the discussion of screen 900 applies to screen 1500 as well.

Although no crop types have been specifically identified in this present document, it should be understood that the systems, apparatus, and processes disclosed herein may be applied to any type of crop. While the foregoing has described what are considered to be the best mode and/or other examples of the present invention, it is understood that various modifications can be made therein and that the subject matter disclosed herein can be implemented in various forms and examples, and that the teachings can be applied in numerous applications, only some of which have been described herein.

This invention has been described herein in considerable detail in order to comply with the patent statutes and to provide those skilled in the art with the information needed to apply the novel principles and to construct and use embodiments of the example as required. However, it is to be understood that the invention can be carried out by specifically different devices and that various modifications can be accomplished without departing from the scope of the invention itself.

1. A method comprising:
determining, by a computing device, that information associated with a geographical area that includes growing crops indicates deficient stand within the geographical area, wherein the information associated with the geographical area comprises at least one of field data and crop data; and
outputting, by the computing device and in response to determining that the information associated with the geographical area indicates deficient stand within the geographical area, at least one notification comprising an indication that the information associated with the geographical area indicates deficient stand.

2. The method of claim 1, wherein determining that the information associated with the geographical area indicates deficient stand comprises:
comparing the information associated with the geographical area with parameters of acceptability corresponding to the growing crops; and
determining that the information associated with the geographical area indicates deficient stand based on the comparison.

3. The method of claim 2,
wherein the geographical area comprises a plurality of grids, and
wherein comparing the information associated with the geographical area with the parameters of acceptability further comprises:
determining a stand score for each grid of the plurality of grids; and
comparing the stand score for each grid of the plurality of grids with the parameters of acceptability.

4. The method of claim 1,
wherein the geographical area comprises a field of growing crops, and
wherein determining that the information associated with the geographical area indicates deficient stand within the geographical area comprises determining that a stand status corresponding to a portion of the field of growing crops is deficient, wherein the portion of the field of growing crops comprises less than all of the field of growing crops.

5. The method of claim 4, wherein determining that the stand status corresponding to the portion of the field of growing crops is deficient comprises determining that a stand population of the portion of the field of growing crops is less than a threshold stand population value.

6. The method of claim 5, wherein the stand population is representative of a number of healthy plants included within the growing crops.

7. The method of claim 4, wherein determining that the stand status corresponding to the portion of the field of growing crops is deficient comprises determining that a stand consistency of the portion of the field of growing crops is less than a threshold stand consistency value.

8. The method of claim 7, wherein the stand consistency is representative of variability of relative locations of plants included within the growing crops.

9. The method of claim 4, wherein determining that the stand status corresponding to the portion of the field of growing crops is deficient comprises determining that a stand quality of the portion of the field of growing crops is less than a threshold stand quality value.

10. The method of claim 9, wherein the stand quality is representative of the general health of plants included within the growing crops.

11. The method of claim 4, wherein the at least one notification further comprises an indication of the location of the portion of the field of growing crops.

12. The method of claim 1, wherein the at least one notification further comprises a recommendation for future action associated with the region of interest.

13. The method of claim 12, wherein the recommendation for future action comprises a recommendation to replant a portion of the region of interest.

14. The method of claim 1, further comprising receiving, by the computing device, the information associated with the geographical area.

15. The method of claim 14, wherein receiving the information associated with the geographical area comprises receiving information associated with the geographical area collected from one or more sensors.

16. The method of claim 15, wherein the one or more sensors are carried by an unmanned aerial vehicle (UAV).

17. The method of claim 14, wherein receiving the information associated with the geographical area comprises receiving image data associated with the geographical area.

18. The method of claim 17, wherein the image data comprises at least one of crop color data, crop texture data, and crop pattern data.

19. A device comprising:
at least one processor; and
one or more storage devices encoded with instructions that, when executed by the at least one processor, cause the at least one processor to:
determine that data associated with growing crops indicates a lack of expected vegetative growth of the growing crops, wherein the data associated with the growing crops comprises at least one of field data and crop data; and
output, in response to determining that the data associated with the growing crops indicates the lack of expected vegetative growth, at least one stand alert including an indication of the lack of expected vegetative growth.

20. A system comprising:
a computer device comprising at least one processor; and
a stand analyzer and alert generator executable by the at least one processor of the computer device and configured to:
identify that data for a field of growing crops indicates a stand deficiency of a portion of the field of growing crops, wherein the portion of the field of growing crops comprises less than all of the field of growing crops;
generate, in response to identifying that the data for the field of cropping crops indicates the stand deficiency of the portion of the field of growing crops, a notification comprising an indication of the stand deficiency; and
transmit, in response to generating the notification, the notification via a communications network.
